(19) United States
(12) Patent Application Publication
(10) Pub. No.: US 2007/0260564 A1
(43) Pub. Date: Nov. 8, 2007

(54) Text Segmentation and Topic Annotation for Document Structuring

(75) Inventors: Jochen Peters, Aachen (DE); Carsten Meyer, Aachen (DE); Dietrich Klakow, Saarbrucken (DE); Evgeny Matusov, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklike Philips Electronics N.V., Eindhoven (NL)

(21) Appl. No.: 10/588,639

(22) PCT Filed: Nov. 12, 2004
(86) PCT No.: PCT/IB04/52404

§ 371 Date: Jan. 22, 2007

(30) Foreign Application Priority Data
Nov. 21, 2003 (EP) 03104315.1

(51) Int. Cl. G06F 15/18; G06F 17/27; G06F 17/30

(52) U.S. Cl. 706/14; 704/9; 707/104.1; 704/E17.007; 707/E17.084

(57) ABSTRACT

The invention relates to a method, a computer program product and a computer system for structuring an unstructured text by making use of statistical models trained on annotated training data. Each section of text in which the text is segmented is further assigned to a topic which is associated to a set of labels. The statistical models for the segmentation of the text and for the assignment of a topic and its associated labels to a section of text explicitly accounts for: correlations between a section of text and a topic, a topic transition between sections, a topic position within the document and a (topic-dependent) section length. Hence structural information of the training data is exploited in order to perform segmentation and annotation of unknown text.

The present invention relates to the field of generating structured documents from unstructured text by segmenting unstructured text into sections and assigning a semantic topic to each section.

The segmentation of a text into a plurality of sections and assigning each section with a label being indicative of the content of the section is an essential and widespread task for the structuring of a text document. A section of text having a distinct relevance to a reader can easily be retrieved within the document by means of an associated label or heading. Based on the label the reader can quickly and effectively identify the content relevance of a section of text. Unfortunately there exists a vast amount of text documents that only provide an insufficient structuring or no structuring at all.

Gathering of information provided by unstructured or weakly structured documents requires extensive reading and/or elaborate searching which is exhausting and very time consuming for the reader. Therefore, extensive research and development has been focused on methods and techniques providing a structure for an unstructured text. Examples of unstructured text are text streams generated by a speech recognition system transcribing recorded speech into machine processible text.

In general, structuring of a text can be considered as two tasks of text segmentation and topic assignment. First a given text is divided into a number of sections by inserting section boundaries. This first step of segmentation has to be performed in such a way that each section corresponds to a semantic topic. In a second step each section of text must be assigned to a label being indicative of the content of the section. The segmentation of the text as well as the assignment of topics to text sections can be performed in a simultaneous way, whence a segmentation is performed with respect to the assignment of a topic to a text section and the assignment of a topic to a text section is performed with respect to the segmentation.

The document U.S. Pat. No. 6,052,657 discloses a technique of segmenting a stream of text and identifying topics in the stream of text. This technique employs a clustering method that takes as input a set of training text representing a sequence of sections, where a section is a continuous stream of sentences dealing with a single topic. The clustering method is designed to separate the sections of input text into a specified number of clusters, where different clusters deal with different topics. Topics are not defined before applying a clustering method to the training text. Once the clusters are defined, a language model is generated for each cluster.

The technique features segmenting a stream of text that is composed of a sequence of blocks of text (e.g. sentences) into segments using a plurality of language models. This segmentation is done in two steps: First, each block of text is assigned to one cluster language model. Thereafter, text sections (segments) are determined from sequential blocks of text which have been assigned to the same cluster language model. For the first step, each block of text is first scored against the language models to generate language model scores for this block of text. A language model score for a block of text indicates a correlation between the block of text and the language model. Second, language model sequence scores for different sequences of language models to which a sequence of blocks of text may correspond are generated. Combining all score information, a best-scoring sequence of language models is determined, thus resulting in an assignment of each sentence sᵢ to some cluster language model slmᵢ.

Segment boundaries in the stream of text are then identified in the second step as corresponding to language model changes in the selected sequence of language models, i.e. to sentence transitions where slmᵢ₊₁ differs from slmᵢ.

The above described technique and method for text segmentation and/or identification of topics focuses on a usage of text emission models and of models for the transitions between clusters assigned to adjacent sentences. In other words, a text segmentation and topic identification is performed by determining scores or likelihoods being indicative of a correlation between text segments and predefined topics and by determining scores or likelihoods being indicative of a correlation between clusters of adjacent sentences. Sections are usually composed of a multitude of sequential sentences, whence the correlation between adjacent clusters include transitions from one cluster to the same cluster. Transition between the same clusters are denoted as “looping” within one fixed cluster. At section boundaries this “looping” ends, i.e. at a section boundary, a transition between two different clusters takes place.

The basic strategy to first assign sentences to clusters and to then determine section boundaries from cluster changes has several shortcomings: The method cannot be extended to capture longer ranging information such as dependencies on more remote sections since these emerge only after the cluster assignment is completed. Also, substructures within sections (such as typical start phrases) cannot be captured in the sentence-by-sentence cluster assignment approach. Furthermore, explicit models for typical lengths of sections cannot be incorporated in this approach.

The present invention aims to provide an improved method, a computer program product, and a computer system for the segmentation of a text and assignment of topics and/or labels to text sections by making use of a multiplicity of statistical information gathered from a training corpus or from several training corpora or from manually coded prior knowledge.

The present invention provides a method of generating a text segmentation model for the segmentation of a text into sections of text on the basis of training data, wherein each section of text is assigned to a topic. The method for generating the text segmentation model generates a text emission model in order to provide a text emission probability being indicative of a section of text being correlated to a topic, a topic sequence model in order to provide a topic sequence probability being indicative of a probability of a sequence of topics within the text, a topic position model in order to provide a topic position probability being indicative of a position of a topic within the text and a topic-dependent section length model in order to provide a section length probability being indicative of a length of a section of text covering some specific topic. Furthermore, the topic sequence model, the topic position model, and the length models operate on the level of complete sections and not on the level of text blocks (sentences) as in U.S. Pat. No. 6,052,657.

The models are trained on training data comprising one or several training corpora. Alternatively some models may also be manually coded from prior knowledge. Based on a training corpus the method determines text emission probabilities indicating correlations between portions of text and semantic topics representing the content of a text portion.

Furthermore, the method further exploits the structure of a training corpus on the basis of the assigned topics. The training corpus not only contains information about the correlation between text portions and topics but also information about the sequence in which the topics occur in the training corpus. The topic sequence model exploits this type of information in order to generate the topic sequence probability. The topic sequence probability indicates the likelihood that a first topic is followed by a second topic within the training corpus.

Furthermore, the structure of the training corpus can be exploited by means of the topic position model generating statistical information about the likelihood that a distinct semantic topic appears at a specific position within the training corpus. More specifically, this position model describes the probability that the first section of some text from the training corpus was labelled by any specific topic, that the second section was labelled by any specific topic, that the third section was labelled by any specific topic, and so on.

Moreover, further structural information about the training corpus is gathered by means of the section length model providing the topic-dependent section length probability. The section length probability provides statistical information about the length of a section which is assigned to a distinct topic. If data are sparse, some topics may be clustered into classes of topics corresponding to e.g. “short”, “medium”, and “long” sections, and more robust length models may be estimated for each class (instead for each topic separately). As a special case, a clustering of all topics into one class resulting into a global section length model being applicable for each topic is conceivable. The inventive method is in particular applicable to so-called organized documents that are characterized by predefined external conditions, such as a predefined or constrained sequence of topics. Organized documents are for example technical manuals, scientific or medical reports, legal documents or transcripts of business meetings, each of which following a typical topic sequence. For example the topic sequence of a scientific report may feature the following sequence: abstract, introduction, theory, experiments, conclusion, summary. The topic sequence of a patent application may look as follows: field of the invention, background, summary, detailed description, description of figures, claims, figures.

The generation of the above mentioned topic sequence model from the training corpus focuses on the sequence of topics as it is extracted from the training corpus.

According to a preferred embodiment of the invention, the method of generating the text segmentation model, i.e. training the model by statistical analysis of the training data, explicitly accounts for various types of organized documents. When for example a training corpus features a large number of training documents being associated to different types of organized documents, the generation of the text segmentation model identifies the different types of documents and extracts statistical information about each document type separately. For example when the training corpus provides a large set of scientific reports, the generated topic sequence probability that the first section in the text is denoted as abstract is close to unity. Similarly, the probability that the document starts with a section “experiments” is, close to zero. Furthermore the topic sequence model gathers statistical information from the training corpus that a first topic is followed by a second topic. The topic sequence model for example keeps track of a probability that the section labelled as “theory” is often followed by a section labelled as “experiments”.

According to a further preferred embodiment of the invention, the method of generating the text segmentation model also keeps track of the position of certain topics within the training corpus. The resulting topic position probability is indicative about the likelihood whether a distinct topic appears near the beginning, in the middle or at the end of a training text. For example the probability that a topic denoted as “conclusion” can be found at the beginning of a document is close to zero whereas a probability that a “conclusion” section can be near the end of a document is quite high.

According to a further preferred embodiment of the invention, the method of generating the text segmentation model further incorporates a statistical analysis of the length of the sections of text within the training corpus. During application, for example, the section length probability of a section denoted as “abstract” will be high when the respective section length does not exceed a few sentences as observed for “abstracts” in the training data. In contrast, a section length probability for an “abstract” section will be close to zero when the respective section covers more than a hundred sentences, unless otherwise observed during training.

According to a further preferred embodiment of the invention, the training corpus comprises text being segmented into sections of text, each of which having assigned a label and having further assigned a topic. This means that the training corpus is provided with an annotated structure. Herein a label represents an individual heading that corresponds to a section. A topic in contrast refers to the content of a section. In this way a topic clusters headings or labels with the same semantic meaning.

For example a section describing an experiment within a scientific report can be labelled in a plurality of different ways, e.g. as “experiments”, “experimental approach”, “experimental setup”. In this way, the method accounts for a huge variety of explicit labels or headings that refer to sections having the same semantic meaning. In contrast to a label, a topic represents an abstract identifier of a section. Each section of text within the training corpus must be assigned to a topic. Also the set of topics, i.e. the number and the specific names of the topics must be provided or must be annotated to the training corpus.

The definition of the topic names as well as the assignment of labels, which may appear in the training text, to the topics has to be performed manually or by some clustering technique. Depending on the structure of the training corpus, the assignment of sections of text to labels or section headings can either be performed manually and/or automatically. When for example the training corpus is segmented into sections that are labelled with headings, these headings can be extracted during the training of the text segmentation model and can further be assigned to a predefined topic. If no labels (headings) are present or if no mapping from labels to topics is defined, then each section has to be hand-annotated with a corresponding topic. In any case the assignment between a section and a corresponding topic must be given.

According to a further preferred embodiment of the invention, the topic sequence model accounts for a plurality of successive topic transitions by making use of a topic transition M-gram model. This means that the topic sequence probability is not restricted to a bigram model which is only indicative of a first section being followed by a second section. Rather, the sequence probability keeps track of the entire topic sequence of a training text or at least of a longer ranging subsequence of topics. By making use of such a M-gram model, the topic sequence probability is informative about a first topic being followed by a second topic, being followed by a third topic, being followed by a fourth topic and so on. The topic sequence probability is generated by applying the topic sequence model by making use of a M-th order Markov process.

The topic sequence probability taking into account the entire topic sequence of a document gives more reliable information about topic transitions than a topic sequence probability which is generated on the basis of a bigram model. The following example illustrates the benefit from using a trigram instead of a bigram. When in an application two topics “Description of figures” and “Detailed description of the invention” appear next to each other in arbitrary order, a sequence of topic one (“Description of figures”) followed by topic two (“Detailed description of the invention”) followed by topic one seems to be plausible if pairwise (bigram) transitions are considered. In contrast, the same sequence is highly unlikely if the full triple of topics (trigram) is considered, where the first appearance of topic one “blocks” a repeated appearance of the same topic two positions later.

According to a further preferred embodiment of the invention, the text emission probability accounts for the position of characteristic text portions within a section of text. This means that the method of generating the text segmentation model explicitly keeps track of distinct word combinations or phrases within the first few sentences of a section. It is very likely that phrases as “to summarize . . . ” or “in conclusion . . . ” appear at the beginning of a section labelled as “summary” or “conclusion”. In this way not only the structure of the document but also the sub-structure of a section is carefully analyzed.

Therefore, not only topic-specific text emission models for a complete section but also statistical models being designed for a particular part of a section are conceivable. Furthermore, the topic-specific text emission model can be weighted differently for various parts of the respective section.

According to a further preferred embodiment of the invention, the determination of the text emission probability, the topic sequence probability, the topic position probability and the generation of the section length probability is performed with respect to a granularity parameter, influencing the number of sections into which the text is segmented. From a technical point of view, the granularity parameter determines a smoothing or re-weighting of the text emission model, the topic sequence model, the topic position model and the section length model. Explicit modifications of the section length model may also be employed in order to influence the segmentation granularity. Depending on the given granularity parameter, the generation of the statistical models accounts for a finer or coarser segmentation of the text. Hence with the help of the granularity parameter, the level on which text segmentation and topic assignment is performed can be modified. A smoothing of the statistical models during training is especially advantageous with respect to the storage capacity or system load of a text segmentation system, because a pre-calculated smoothed statistical model requires less storage and is easier accessible than an online smoothing during application.

Whereas the above described features of the inventive method focus on the training procedure in order to provide statistical information of the training data in form of text emission probability, topic sequence probability, topic position probability and section length probability, in the following the application of the text segmentation model resulting from the training procedure described above is described. Application of the text segmentation model performs a text segmentation as well as a topic assignment to text section.

According to a preferred embodiment of the invention, the text segmentation models trained on the basis of the training corpus can be applied by a method of text segmentation. This method of text segmentation makes explicit use of the models for the text emission probability, the topic sequence probability, the topic position probability and the section length probability. This text segmentation method is further designed to perform a segmentation of unstructured text documents that belong to a distinct type of organized documents. Such an unstructured text document may result as output from a speech recognition system automatically transcribing the dictated text of e.g. a scientific report or patent application.

The method of text segmentation makes use of the text segmentation model providing statistic information of the training data. The method of text segmentation exploits the text emission probability, the topic sequence probability, the topic position probability and the section length probability in order to perform a text segmentation and topic assignment.

The statistical information gathered during the training process and being provided by the text emission model, the topic sequence model, the topic position model as well as the topic-dependent section length model is explicitly used for the segmentation of an unstructured text. The method of text segmentation performs a segmentation of the text by processing the provided probabilities. Therefore, the method makes use of the text emission model in order to determine a probability, that a given text portion is correlated to a topic. By means of the topic transition model, the method of text segmentation determines a probability, that a text portion being assigned to a first topic is followed by a text portion being assigned to a second topic. Correspondingly, the topic position model is exploited in order to determine a probability, that a text portion is assigned to a topic with respect to the position of the text portion within the text. The method of text segmentation makes further use of the section length model providing statistical information about the topic-dependent length of sections.

The segmentation of the unstructured text into sections of text as well as the assignment of these text sections to predefined topics accounts for the complete statistical information gathered during the generation process of the text segmentation model on the basis of the training data.

According to a further preferred embodiment of the invention, the application of the text segmentation model is performed by means of a two-dimensional simultaneous optimization over the section boundaries and over the assigned topics. This optimization aims to find an optimal segmentation of a given word stream of N words w₁^{N}:=w₁, . . . , w_{N} into K sections that are labeled by the topics t₁^{K}:=t₁, . . . , t_{K} and characterized by the section end positions, i.e. word indices n₁^{K}:=n₁, . . . , n_{K}. The final task to find an optimal segmentation of the text with respect to the text emission probability, the topic sequence probability, the topic position probability and the section length probability reduces to the following optimization criterion:

$${arg max}_{{t}_{1}^{K} , {n}_{1}^{K - 1} , K} \{ p ( {t}_{end} \vert {t}_{K} ) \cdot {\prod }_{k = 1}^{K} ( p ( {t}_{k} \vert {t}_{k - 1} ) \cdot p ( Δ {n}_{k} \vert {t}_{k} ) \cdot {\prod }_{n = {n}_{k - 1} + 1}^{{n}_{k}} p ( {w}_{n} \vert {t}_{k} , n - {n}_{k - 1} ) ) \} .$$

Here, the term p(tₖ|tₖ₋₁) reflects the topic transition probability, the term p(Δnₖ|tₖ) with Δnₖ=(nₖ −nₖ₋₁) represents the section length probability and the term p (wₙ|tₖ, n−n k₋₁) reflects the text emission probability even taking into account a position dependency of a sequence of words within a text section. For reasons of simplicity the probabilities illustrated here are given as bigram probabilities. The inventive method also accounts for trigram or M-gram probabilities and/or position dependencies of each topic and can be customized correspondingly.

When for example the text emission probability equals 0.5, that a first portion of text is associated to a first topic and a second portion of the stream of text is associated to a third topic with a text emission probability of 0.5 and the same second portion of the text stream is correlated to a second topic with a text emission probability of 0.3, the method of text segmentation assigns the first topic to the first portion of a text stream and assigns the third topic to the second portion of the text stream. Taking further into account a topic sequence probability with a topic transition probability of 0.9 for the transition of topic one to topic two and with a topic transition probability of 0.2 for the transition of topic one to topic three, the method of text segmentation may determine that the second portion of the text stream is assigned to the second topic instead of the third topic.

Not only the assignment of topics to sections of the text, but also the segmentation of the text into sections of text itself exploits the probabilities provided by the statistical models referring to the text emission, the topic sequence, the topic position and the section length. Furthermore the topic sequence probability can be explicitly based on a topic transition M-gram model. Hence the topic sequence probability is not only informative of a transition between a first and a second topic but in fact provides statistic information of successive transitions between multiple topics, potentially covering the entire text document.

According to a further preferred embodiment of the invention, the segmentation of an unstructured document as well as the assignment of a topic to a section of text is performed with respect to the topic position probability. When for example according to the text emission probability and to the topic sequence probability, two or more different configurations of text segmentation and topic assignment feature a similar probability, the topic position probability may further serve as a decision criterion between these two configurations.

When for example the combined text emission probability and topic sequence probability give a combined probability of 0.5 for a configuration of a text segmentation in which topic one is followed by topic two and giving further a combined probability of 0.45 for a configuration that topic one is followed by topic three, the topic position probability may provide further statistic information in order to make a correct decision. When in this case the topic position probability of topic three exceeds by far the topic position probability of topic two, the configuration that topic one is followed by topic three becomes more plausible than the other configuration for which topic one was followed by topic two.

According to a further preferred embodiment of the invention, the section length probability can further be exploited for the purpose of text segmentation and topic assignment. When for example according to the text emission probability the topic sequence probability and the topic position probability of a first configuration of text segmentation and topic assignment has a slightly higher probability than a second configuration, the section length probability may provide additional information that can serve as a further decision criterion.

When for example within the first configuration a first section has been assigned as “abstract” topic with a length exceeding by far the typical length of an “abstract” section, this first configuration is very unlikely to be realistic according to the section length probability. By evaluating and accounting for the section length probability the method of text segmentation and topic assignment may in this case decide for a different configuration.

According to a further preferred embodiment of the invention, the text segmentation as well as the assignment of text sections to predefined topics also accounts for the sub-structure of a section. The distinctive power of a text emission model can be enhanced appreciably by exploiting the fact that certain topic specific expressions typically appear in the beginning part of a section. This fact can be exploited by making explicit use of text emission models being specified for defined parts of a section. Furthermore, a variation of the weight or impact of the different probabilities within distinct parts of a section can be applied.

Downweighting the text emission probabilities of the many words in the “body” of a long section may for example avoid local transitions to other topics if some few keywords appear that are more closely related to other topics. Appropriate weighting techniques can also be used to control the granularity of the segmentation from an aggressive segmentation with many local transitions to the locally “best” topic to a more conservative segmentation only after observing sufficiently many words indicating a topic change. Such weighting techniques comprise a simple (position-dependent) exponential downscaling of each word's probability term or smoothing techniques such as linear or log-linear interpolation of the topic-specific model with a global (topic-independent) model.

According to a further preferred embodiment of the invention, the method of text segmentation further assigns a label to each section of text. The label which is assigned to a section of text is chosen from a set of labels that are associated to the topic which is assigned to said text section. Whereas the topic represents a generic term and refers to a semantic meaning of a section, a label represents a concrete heading of a section. Whereas the labels may represent a plurality of individual headings according to personal preferences, the topics are given in a predefined way and are used for the segmentation and structuring of the unstructured text.

According to a further preferred embodiment of the invention, the granularity of the segmentation can be adjusted by means of a granularity parameter which can be specified according to a user's preferences. The granularity parameter specifies a finer or coarser segmentation of the document resulting in an insertion of more or less labels or headings in the document. Besides from the above mentioned weighting schemes for the text emission models the segmentation granularity may also be controlled by modified section length models or by an additional explicit model for the expected number of sections per document.

According to a further preferred embodiment of the invention, a label can be assigned to a section of text according to an ordered set of labels that is associated to a topic being assigned to the section of text. Typically an entire set of labels is associated to a topic. Since each section of text is assigned to a topic it is also indirectly assigned to the corresponding set of labels which is associated to the topic. The method now has to select one label of the set of labels and assign the selected label to a section of text, i.e. insert the label as a heading for a text section.

The selection of a single label from the set of labels can be performed in different ways. When for example the set of labels is provided in an ordered way, the first label of the ordered set of labels is assigned to the relevant section of text. Alternatively, the method checks whether a label of the provided set of labels matches an expression within the relevant section. This is the case when section headings are already present in the unstructured text, as for example when the text stems from a transcribed dictation in which the headings were explicitly dictated. Furthermore, the assignment of a label to a text section can be performed with respect to a count statistics based on a training corpus. This count statistics keeps track of a correlation between a topic and associated labels. Especially in this case a default label can be specified for each topic. This default label is determined on the basis of the training corpus and represents that the default label is the most probable one to be correlated to a topic.

According to a further preferred embodiment of the invention, the result of the text segmentation and topic and/or label assignment as well as the generation of the text segmentation model can be modified in response to a user's decision. This means that a user has complete access to alter the text segmentation and the assignment of topics and labels of text sections within a text as well as having access to alter the text emission probability, the topic sequence probability, the topic position probability and the section length probability. Modifications of the latter mentioned probabilities incorporates a continuous improvement of the training data based on decisions and/or corrections performed by a user.

Furthermore, the method keeps track of manually introduced modifications of the segmented text. A preferred selection of labels or segmentation into text sections can be further processed in order to modify the generated statistical models. In such a case the trained correlation between text sections and topics, or labels is updated or overruled by the manually inserted modification.

In the following, preferred embodiments of the invention will be described in greater detail by making reference to the drawings in which:

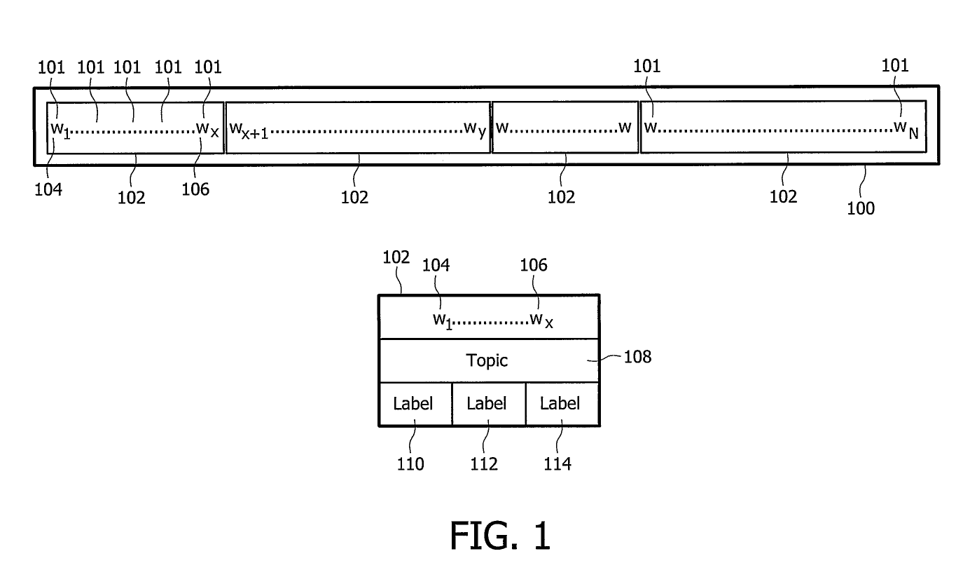

FIG. 1 illustrates a block diagram of a text being divided into a number of sections,

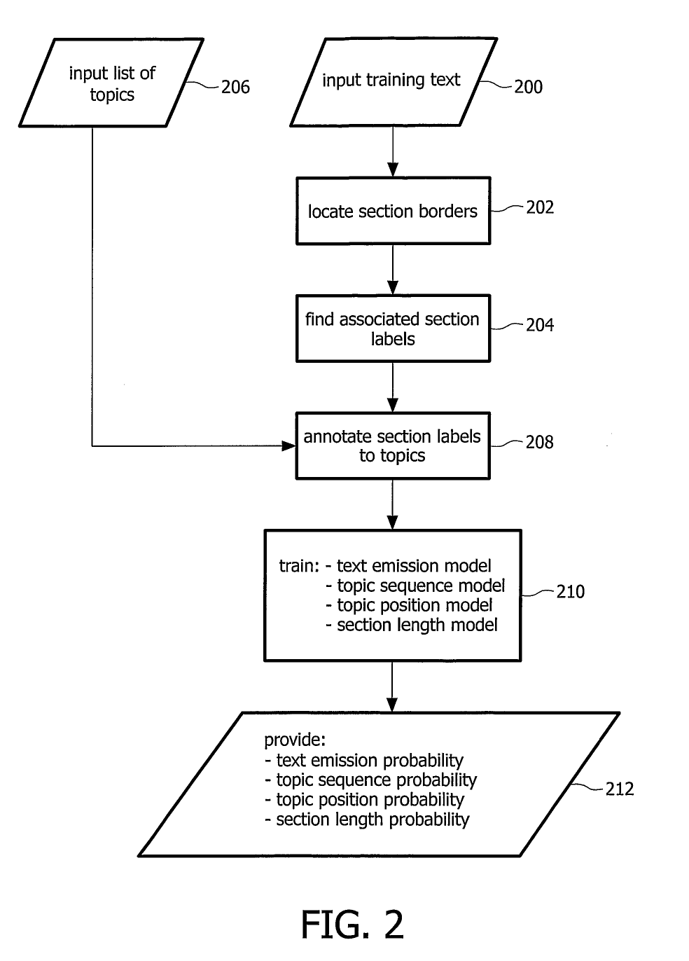

FIG. 2 is illustrative of a flow chart of the training of the text segmentation model based on the training corpus,

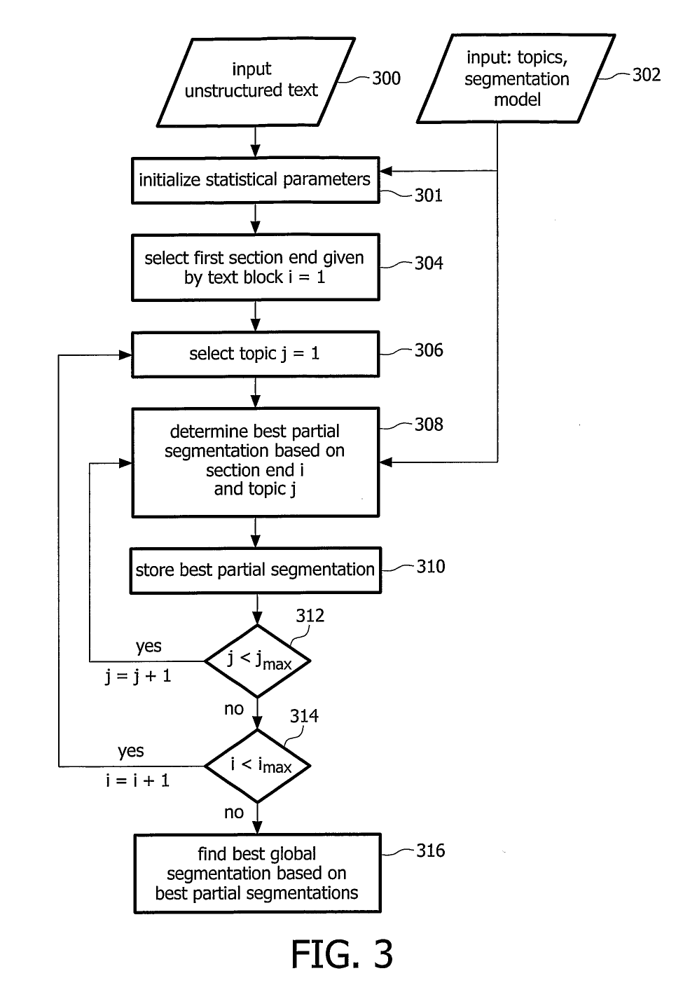

FIG. 3 is illustrative of a flow chart for performing a text segmentation and topic assignment,

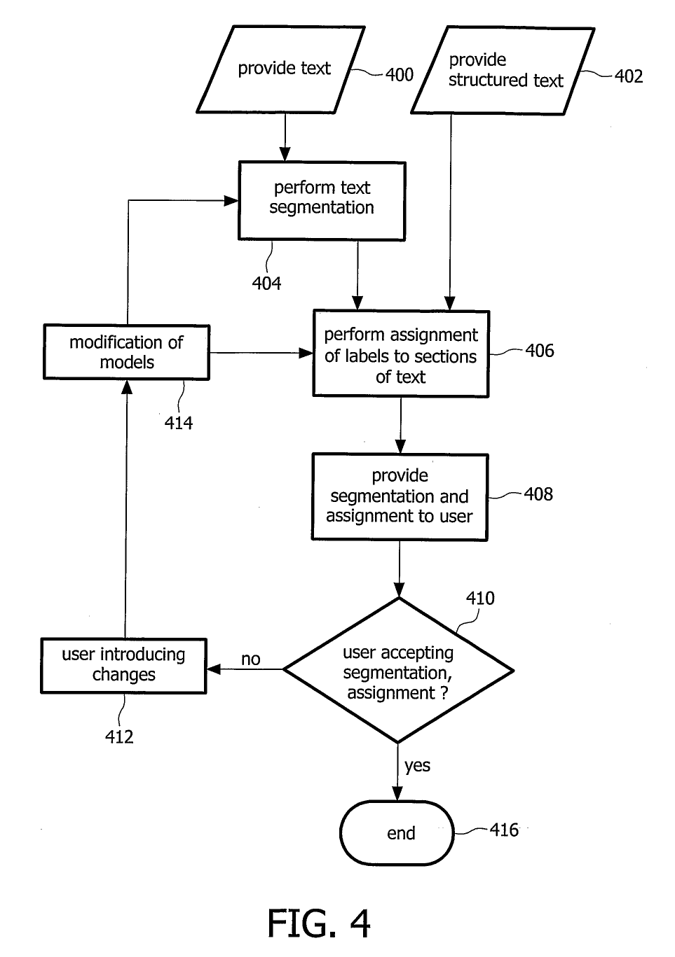

FIG. 4 is illustrative of a flow chart of text segmentation incorporating user interaction.

FIG. 1 shows a block diagram of a text 100 comprising a number of words w₁ . . . w_{N}. The text 100 is segmented into a number of sections 102. For example the first section 102 starts with the first word of the text w₁ 104 and ends with the word wₓ 106. The next section 102 starts with the next word of the stream of words wₓ₊₁ and ends with the word w_{y}. The section borders of the remaining sections 102 are defined in a similar way. The section 102 is defined by its section borders characterized by the position of the first word w₁ 104 and by the position of the last word w₁ 106. Here the expression word refers to words, numbers, letters or other types of text signs.

A section 102 which is defined as a concatenated sequence of words 101 is further assigned to a topic 108. The topic 108 is further associated to at least one label 110. Typically the topic 108 refers to a set of labels 110, 112, 114. The topic 108 represents a semantic meaning of the section 102, whereas the labels 110, 112, 114 refer to slightly different headings or labels of a section. The number as well as the denotation of the topics is given in a predefined way, whereas the labels 110, 112, 114 associated to the topic 108 may differ slightly. For example a section within a scientific report describing experiments may be assigned to a topic denoted as “experiment” but the associated labels can be denoted differently as for example “experimental result”, “experimental approach” or as “experimental setup”.

During the training process, i.e. the generation of the text segmentation model on the basis of the training corpus, each section of the annotated training corpus must be assigned to a predefined topic. Based on this assignment the method of generating the text segmentation model is able to extract the text emission probability, the topic sequence probability, the topic position probability as well as the section length probability that are needed in order to perform a segmentation of an unstructured text and assign labels and topics to the resulting text sections. During the training process labels or headings being associated to the training corpus can be extracted by the training method and automatically be assigned to the corresponding topic.

FIG. 2 illustrates a flow chart for the training process, i.e. for the generation of the text segmentation model based on the annotated training corpus. In the first step 200 a training text must be inputted, i.e. provided to the method. The method of generating the text segmentation model then proceeds with step 202 in which the section borders of the training text are located. In the next step 204 labels being associated to the sections are found and extracted. The method further receives a predefined input list of topics in step 206. This input list of topics as well as the section labels (extracted in step 204) are provided to step 208 which maps each labelled section to its corresponding topic.

Alternatively the steps 202, 204 and 208 can be skipped when the sections within the training corpus are already assigned to topics. In this case labels need not be extracted (or even present in the training data). In the following step 210, the relevant models for the generation of the text segmentation models are trained. This training procedure incorporates the training of one or several text emission models for various parts of each section, the topic sequence model, the topic position model and the section length model. As a result of the training procedure corresponding probabilities are generated. The resulting probabilities, i.e. the text emission probability, the topic sequence probability, the topic position probability and the section length probability are provided in the final step 212.

Especially the text emission model can be trained in order to distinguish different text regions within each section, e.g. section-initial models versus models for the rest of the section.

When a granularity parameter such as a specific weighting scheme for text emission models or some modification for section length models is specified, the models can be modified accordingly during the training procedure. Alternatively, the granularity parameter can be applied during the segmentation process, thus resulting in an “online” modification of the affected models.

For practical reasons the provided probabilities of step 212 are stored by some kind of storing means. These probabilities represent a vast amount of statistical information that can be extracted from the training data. In this way not only a correlation between single words or characteristic sentences to predefined topics but also the sequence of topics as well as the position of certain topics and the length of specific sections is accounted for.

FIG. 3 illustrates a flow chart for performing a text segmentation and topic assignment on the basis of the two-dimensional simultaneous optimization procedure which is also known as two-dimensional dynamic programming to those skilled in the art. In a first step 300, unstructured text is inputted. In the following step 301, statistical parameters needed by the optimization procedure are initialized. These statistical parameters refer to the text emission probability, the topic transition probability, the section length probability and the topic position probability. This initialization step extracts information provided by the segmentation model that has been trained on the basis of the training data. Therefore, step 302 provides the parameters needed for the initialization that is performed in step 301.

After the initialization of the statistical parameters, the method proceeds with step 304, where a first text block with a text block index i=1 is selected. A text block can either comprise a single word or a sequence of words, such as e.g. an entire sentence. After the first text block has been selected in step 304, a topic index j referring to a topic of the set of topics is initialized to j=1 in step 306.

For the given combination of text block i and topic j, the method determines a best partial segmentation in step 308. The best partial segmentation assumes that a section ends at the end of text block i in the inputted text. Based on this assumed section end, the step 308 performs an optimization procedure determining a partial path score for all combinations of text segmentation and topic assignment. The best partial segmentation of step 308 performs two nested loops referring to the text segmentation and topic assignment and calculates the partial path score. The best partial segmentation is calculated by determining the best partial path score of all calculated path scores.

For each combination of text block i with topic j, the best partial segmentation is determined in step 308 and successively stored in step 310. In step 312 the topic index j is compared with the maximum topic index jₘₐₓ and when j is smaller than jₘₐₓ, the method returns to step 308 by incrementing the topic index j by one. When in step 308 the topic index j equals jₘₐₓ, the method proceeds with step 314. Step 314 compares the text block index i with the maximum text block index iₘₐₓ representing the end of the inputted text. When in step 314 i is smaller than iₘₐₓ, the text block index i is incremented by one and the method returns to step 308. When in step 314 i equals iₘₐₓ, then the method proceeds to step 316 in which a best global segmentation of the text is performed. This global segmentation makes use of the best partial segmentations for all topics j stored by step 310. This final optimization step may include a final topic transition probability from the last topic j to a fictitious end topic which serves as additional knowledge source encoding statistical information about typical final topics in a document. This term was denoted p(t_{end}|t_{K}) in the exemplary formulas described above. In this way the two-dimensional simultaneous optimization procedure is performed by calculating an optimized global segmentation of the text on the basis of a set of determined partial best segmentations. The text segmentation and topic assignment are performed in a simultaneous way, i.e. the segmentation of the text is performed with respect to the assignment of a topic to a section and vice versa.

FIG. 4 is illustrative of a flow chart of the text segmentation method incorporating user interaction. In step 400 unstructured text is provided and in the successive step 404 an appropriate text segmentation is performed in accordance to the present invention. In the following step 406 the assignment of labels to the sections of text is performed. Alternatively to receiving segmented text from step 404, step 406 can also obtain structured but unlabelled text from step 402. After the assignment of labels to the sections of text in steps 406, the executed segmentation and assignment is provided to a user in step 408. In the following step 410 the user has access to modify the performed segmentation and/or assignment. When the user accepts the performed segmentation and assignment in step 410 the method ends in step 416. In the other case when the user rejects the performed segmentation and/or assignment in step 410 the method proceeds with step 412 in which the user can introduce changes. The introduction of changes in step 412 refers to the segmentation as well as to the assignment of topics and/or labels to the sections of text.

In the following step 414 changes made in step 412 are implemented into the text segmentation model in step 414. Implementing changes into the text segmentation model results in a modification of the text emission model, the topic sequence model, the topic position model as well as the section length model. The modified models resulting from step 414 can then be repeatedly used to perform the text segmentation of step 404 as well as to perform the assignment of labels to sections of text in step 406. Furthermore, the modified models can be used for the subsequent segmentation of new documents, thus utilizing the feedback from the user and adapting to his or her preferences.

The invention therefore provides a method for structuring of organized documents which follow a typical structure. The structuring method can be applied to unstructured documents as they are obtained for example from a speech recognition or speech transcription system. The structuring of such documents incorporates the segmentation of the document into sections as well as an assignment of these sections with labels. These segmentation and assignment processes are based on training data and/or manually coded prior knowledge. The generation as well as the usage of the training data explicitly accounts for the structure of the training documents, i.e. the assignment of topics to sections, the topic sequence, the topic position as well as the length of sections of text of the training corpus.

### LIST OF REFERENCE NUMERALS

100 text
101 word
102 section
104 word
106 word
108 topic
110 label
112 label
114 label

1. A method of generating a text segmentation model for the segmentation of a text (100) into sections of text (102) on the basis of training data, wherein each section of text is assigned to a topic (108), the method of generating the text segmentation model comprising the steps of:
generating a text emission model to provide a text emission probability being indicative of a section of text (102) being correlated to a topic (108),
generating a topic sequence model to provide a topic sequence probability being indicative of a probability of a sequence of topics within the text,
generating a topic position model to provide a topic position probability being indicative of a position of a topic (108) within the text (100),
generating a section length model to provide a section length probability being indicative of the length of a section of text (102) that is assigned to a topic (108).

2. The method according to claim 1, wherein the training data comprises at least one text (100) segmented into sections of text (102), each section of text having assigned a topic (108).

3. The method according to claim 1, wherein the topic sequence model is adapted to account for a plurality of successive topic transitions by making use of a topic transition M-gram model.

4. The method according to claim 1, wherein the text emission probability is further determined with respect to the position of characteristic text portions within a section of text (102).

5. The method according claim 1, wherein the text emission probability, the topic sequence probability, the topic position probability and the section length probability are determined with respect to a granularity parameter, influencing the number of sections (102) into which the text (100) is segmented.

6. A method of segmentation of a text (100) into sections of text (102) by making use of a text segmentation model being generated in accordance to claim 1, the segmentation of the text being performed by selecting at least one probability of the group of probabilities consisting of: text emission probability, topic sequence probability, topic position probability and section length probability, and using the selected probabilities, the segmentation of the text further comprising assigning a topic (108) to each section of text (102).

7. The method according to claim 6, further comprising assigning a label (110, 112, 114) to each section of text, the label belonging to a set of labels (110, 112, 114) associated to the topic (108) being assigned to each section of text (102).

8. The method according to claim 6, wherein a granularity parameter influences the number of sections (102) into which the text (100) is segmented.

9. The method according to claim 7, further comprising:
assigning a label (110, 112, 114) to a section (102) according to an ordered set of labels being associated to a topic (108) assigned to the section, assigning a label to a section (102) with respect to a text portion within the section, the text portion being characteristic for the label (110, 112, 114),
assigning a label (110, 112, 114) to a section (102) with respect to a count statistics based on the training data, the count statistics being indicative about a correlation probability between a topic (108) and the label (110, 112, 114).

10. The method according to claim 1, wherein modifications of the text emission probability, the topic sequence probability, the topic position probability and the section length probability are performed in response to a user's decision, the user having access to alter the text segmentation and assignment of topics (108) and labels (110, 112, 114) to sections of text (102).

11. A computer program product for the generation of a text segmentation model for the segmentation of a text (100) into sections of text (102) on the basis of annotated training data, wherein each section of text is assigned to a topic (108), the computer program product comprising program means for:
generating a text emission model to provide a text emission probability being indicative of a section of text (102) being correlated to a topic (108),
generating a topic sequence model to provide a topic sequence probability being indicative of a probability of a sequence of topics (108) within the text (100),
generating a topic position model to provide a topic position probability being indicative of a position of a topic (108) within the text (100),
generating a section length model to provide a section length probability being indicative of the length of a section of text (102) that is assigned to a topic.

12. The computer program product according to claim 11, wherein the topic sequence model is adapted to account for a plurality of successive topic transitions by making use of a topic transition M-gram model, and wherein the text emission probability is further determined with respect to the position of characteristic text portions within a section of text (102).

13. A computer program product for the segmentation of a text (100) into sections of text (102) by making use of a text segmentation model generated by a computer program product in accordance to claim 11, the computer program product for the segmentation of the text comprising program means for the segmentation of the text, the program means selecting at least one probability of the group of probabilities consisting of: text emission probability, topic sequence probability, topic position probability and section length probability, and using the selected probabilities, the program means being further adapted to assign a topic (108) to each section of text (102).

14. The computer program product according to claim 13, wherein a granularity parameter defines the number of sections (102) into which the text (100) is segmented.

15. The computer program product according to claim 14, further comprising program means being adapted to:
assign a label (110, 112, 114) to a section (102) according to an ordered set of labels being associated to a topic (108) assigned to the section,
assign a label (110, 112, 114) to a section (102) with respect to a text portion within the section, the text portion being characteristic for the label,
assign a label (110, 112, 114) to a section (102) with respect to a count statistics based on the training data, the count statistics being indicative about a correlation probability between a topic and the label.

16. A computer program product according to claim 15, further comprising program means in order to perform modifications of the text emission probability, the topic sequence probability, the topic position probability and the section length probability in response to a user's decision, the user having access to alter the text segmentation and assignment of topics (108) and labels (110, 112, 114) to sections of text (102).

17. A computer system for the generation of a text segmentation model for the segmentation of a text (100) into sections of text (102) on the basis of annotated training data, wherein each section of text is assigned to a topic (108), the computer system comprising:
means for generating a text emission model to provide a text emission probability being indicative of a section of text (102) being correlated to a topic (108),
means for generating a topic sequence model to provide a topic sequence probability being indicative of a probability of a sequence of topics within the text,
means for generating a topic position model to provide a topic position probability being indicative of a position of a topic within the text,
means for generating a section length model to provide a section length probability being indicative of the length of a section of text (102) that is assigned to a topic.

18. The computer system according to claim 17, wherein the topic sequence model is adapted to account for a plurality of successive topic transitions by making use of a topic transition M-gram model, and wherein the text emission probability is further determined with respect to the position of characteristic text portions within a section of text (102).

19. A computer system for the segmentation of a text (100) into sections of text (102) by making use of a text segmentation model generated in accordance to claim 17 by a computer system, the computer system for the segmentation of the text comprising means being adapted to select at least one of the group of probabilities consisting of: text emission probability, topic sequence probability, topic position probability and section length probability, and using the selected probabilities, the computer system means being further adapted to assign a topic (108) to each section of text (102).

20. The computer system according to claim 19, further comprising:
means for assigning a label (110, 112, 114) to a section (102) according to an ordered set of labels being associated to a topic (108) assigned to the section,
means for assigning a label (110, 112, 114) to a section (102) with respect to a text portion within the section, the text portion being characteristic for the label,
means for assigning a label (110, 112, 114) to a section with respect to a count statistics based on the training data, the count statistics being indicative about a correlation probability between a text portion and the label.
